(19) United States
(12) Patent Application Publication
(10) Pub. No.: US 2017/0142175 A1
(43) Pub. Date: May 18, 2017

(54) METHOD AND DEVICE FOR REFRESHING LIVE BROADCAST PAGE

(71) Applicants: Le Holdings (Beijing) Co., Ltd., Beijing (CN); LETV SPORTS CULTURE DEVELOP(BEIJING) CO.,LTD., Beijing (CN)

(72) Inventors: Dongchen HUO, Beijing (CN); Ranyang WANG, Beijing (CN); Zhenhua YAN, Beijing (CN)

(21) Appl. No.: 15/245,210

(22) Filed: Aug. 24, 2016

Related U.S. Application Data
(63) Continuation of application No. PCT/CN2016/082624, filed on May 19, 2016.

(30) Foreign Application Priority Data
Nov. 16, 2015 (CN) 201510785602.7

(51) Int. Cl. H04L 29/06; H04L 12/26; H04L 29/08

(52) U.S. Cl. CPC H04L 65/4076; H04L 65/80; H04L 67/02; H04L 43/08; H04N 21/4758

(57) ABSTRACT

Disclosed are a method and a device for refreshing a live broadcast page. The method includes: obtaining current state information of the live broadcast page, and determining whether a current live broadcast state of the live broadcast page indicates that the live broadcast is finished according to the current state information; if determining that the current live broadcast state of the live broadcast page indicates that the live broadcast is not finished, sending an obtaining request to a server for obtaining actual state information of the live broadcast page; determining whether the actual state information is consistent with the current state information; and if the actual state information is not consistent with the current state information, refreshing the live broadcast page according to the actual state information.

### CROSS REFERENCE TO RELATED APPLICATIONS

This application is a continuation of International Application No. PCT/CN2016/082624, filed on May 19, 2016, which is based upon and claims priority to Chinese Patent Application No. 201510785602.7, filed on Nov. 16, 2015, the entire contents of which are incorporated herein by reference.

### TECHNICAL FIELD

The present disclosure generally relates to the Internet technical field, and more particularly to a method and a device for refreshing a live broadcast page.

### BACKGROUND

With development of Internet technologies, users can view various live shows on web pages. However, during the viewing, if the broadcast state of the web pages changed, users need to manually refresh the web pages to continue.

For example, if a user wants to view a live broadcast of a sport event, the user needs to firstly enter a live broadcast page for the event. If the live broadcast is not started after the entering the user can only view the page before the live broadcast. If the user wants to view full-length live broadcast of the event, he/she has to frequently check whether the starting time of the live broadcast is expired, and when the starting time of the live broadcast is expired, he/she need to manually refresh the web page to switch the web page from the state of not started to in progress for viewing the live broadcast of the event. If the user does not pay attention to whether the starting time of the live broadcast is expired or not, he/she likely, after the start of the live broadcast, manually refreshes the web page to switch the state of web page from not started to in progress, and then view the live broadcast. As a result, the user cannot view the full-length live broadcast of the event, thereby resulting in a bad user experience.

There exists the mentioned defect in prior arts that is resulted from the manual refreshing of the live broadcast state by users after entry of the live broadcast page. Thus, how to present page contents matching real-time broadcast state to users according to the live broadcast state becomes an urgent need in live broadcasting on web pages.

### SUMMARY

The present disclosure provides a method and a device for refreshing a live broadcast page in order to overcome the defect in prior arts that the live broadcast state of the live broadcast page can be changed only by manual refresh, by realizing an automatic refresh of the live broadcast page.

In a first aspect, embodiments of the present disclosure provide a method for refreshing a live broadcast page for a live broadcast, implemented by a client, including:

obtaining current state information of the live broadcast page, and determining whether current live broadcast state of the live broadcast page is finished according to the current state information;

if determining that the current live broadcast state of the live broadcast page is not finished, sending an obtaining request to a server for obtaining actual state information of the live broadcast page;

determining whether the actual state information is consistent with the current state information; and

if the actual state information is not consistent with the current state information, refreshing the live broadcast page according to the actual state information.

In a second aspect, embodiments of the present disclosure provide an electronic device, including:

at least one processor; and

a memory communicably connected with the at least one processor for storing instructions executable by the at least one processor, wherein execution of the instructions by the at least one processor causes the at least one processor to perform any methods for refreshing a live broadcast page mentioned by embodiments of the present disclosure.

In a third aspect, embodiments of the present disclosure provide a non-transitory computer-readable storage medium storing executable instructions that, when executed by an electronic device, cause the electronic device to perform any methods for refreshing a live broadcast page mentioned by embodiments of the present disclosure.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a flowchart illustrating a method for refreshing a live broadcast page in accordance with some embodiments;

FIG. 2 is a block diagram illustrating a structure of a device for refreshing a live broadcast page in accordance with some embodiments; and

FIG. 3 is a block diagram illustrating a structure of an electronic device in accordance with some embodiments.

### DETAILED DESCRIPTION

In order to make objectives, technical solutions and advantages of embodiments of the present disclosure more clear, technical solutions in embodiments of the present disclosure will be described clearly and completely with combination of drawings. It should be noted that the following embodiments are illustrative only, rather than limiting the scope of the disclosure.

At present, when viewing a live show on a web page, if a user enters the live broadcast page before the start of the show, he/she can only enter a live broadcast page which actually plays the show by manually refreshing the page at the starting time of the show. Such approach requires users to frequently check whether the starting time of the show is expired, and sometimes users cannot view full-length live shows, thereby resulting in a bad user experience.

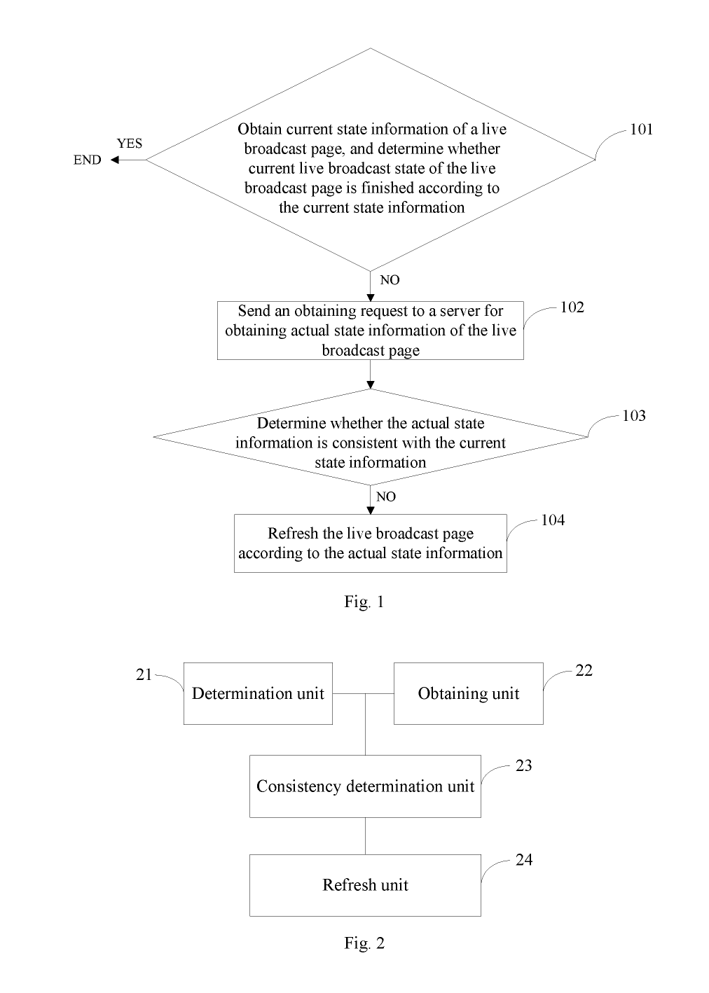

In order to overcome the defect that the state of the live broadcast can only be changed by manual refresh of users after entry of the live broadcast page, embodiments of the present disclosure provide a method for refreshing a live broadcast page, implemented by a client. As shown in FIG. 1, the method can include the following steps.

In 101, a client obtains current state information of the live broadcast page, and determines whether current live broadcast state of the live broadcast page is finished according to the current state information.

If a user wants to view a live show, he/she firstly enters a live broadcast page. If the show is not started when the user enters the live broadcast page, the contents of the show cannot be displayed on the live broadcast page. If the show has started when the user enters the live broadcast page, the contents of the show can be displayed on the live broadcast page. If the show is finished when the user enters the live broadcast page, the contents of the show cannot be displayed on the live broadcast page. In the case where the show is finished when the user enters the live broadcast page, the user can view the show again only if a server and a client end provide on-demand play or replay function, and otherwise, the flow for obtaining the current state information of the live broadcast page can be finished. In actual circumstances, users may enter live broadcast pages under any one of the above stated cases, and thus step 101 needs to be performed in embodiments of the present disclosure to obtain the current state information of the live broadcast page, and whether the current live broadcast state of the live broadcast indicates that the live broadcast is finished can be determined according to the current state information. The obtaining of the current state information of the live broadcast page refers to obtaining of the current live broadcast state of the live broadcast page at the time when the user enters the live broadcast page. Then, whether the live broadcast on the page is finished can be determined according to the current live broadcast state.

In 102, the client sends an obtaining request to a server for obtaining actual state information of the live broadcast page.

If it is determined in 101 that the current live broadcast state of the live broadcast page indicates that the live broadcast is not finished, it indicated that the page needs to be refreshed for changing the current live broadcast state into the actual live broadcast state. Thus, embodiments of the present disclosure need to perform step 102 to send an obtaining request to the server for obtaining the actual state information if it is determined that the current live broadcast state of the live broadcast page indicates that the live broadcast is not finished.

In 103, the client determines whether the actual state information is consistent with the current state information.

There exist the following situations in prior arts. For example, a user enters the live broadcast page before the live show is started. If the user does not manually refresh the page, the page at the user side remains in the state before the live show is started even after the live show has been started at the server. This results in that the current state information and the actual state information of the live broadcast page are not consistent with each other. As another example, in a case where the live broadcast on this page becomes stuck to make the broadcast pause, when the live broadcast of the show is finished at the server, if the user does not manually refresh the page, the live broadcast at the user side is still in an in-progress state. This results in that the current state information and the actual state information of the live broadcast page are not consistent with each other too. Thus, the actual state information of the live broadcast page obtained in step 101 is not necessarily consistent with the actual state information of the live broadcast page obtained in step 102. If the current state information of the live broadcast page is consistent with the actual state information at the server, it is indicated that refresh of the live broadcast page is not necessary for now; if the current state information of the live broadcast page is not consistent with the actual state information at the server, it is indicated that refresh of the live broadcast page is necessary. Thus, embodiments of the present disclosure need to perform step 103 to determine whether the actual state information is consistent with the current state information.

In 104, the client refreshes the live broadcast page according to the actual state information.

If it is determined in step 103 that the actual state information is not consistent with the current state information, it is indicated that the current live broadcast state and the actual live broadcast state of the live broadcast page are out of sync. Thus, it is needed to perform step 104 to refresh the live broadcast page according to the actual state information. In this way, by obtaining and comparison of the current state information and the actual state information of the live broadcast page, refresh of the live broadcast page can be automatically performed, without manual operation of users. Thus, the present disclosure can ensure that page contents matching the actual live broadcast state can be automatically presented on the live broadcast page for users according to the actual state information.

In the method for refreshing a live broadcast page provided by embodiments of the present disclosure, after entry of the live broadcast page, current state information of the live broadcast page is obtained to determine whether a current live broadcast state of the live broadcast page indicates that the live broadcast is finished; if the live broadcast is not finished, an obtaining request is automatically sent to a server to obtain actual state information of the live broadcast page; if it is determined that the actual state information is not consistent with the previously obtained current state information, the live broadcast page is automatically refreshed according to the actual state information to enable the live broadcast page to jump to a page corresponding to the actual broadcast state. The technical solutions in embodiments of the present disclosure realize real-time refresh of the live broadcast page at a client end according to the live broadcast state at the server so as to automatically present page contents matching the actual live broadcast state to users. Thus, the defect in prior arts that users have to manually refresh the pages to enable the state of the live broadcast page to be synchronized with the actual live broadcast state can be overcome.

For the purpose of better understanding the method as shown in FIG. 1, respective steps in FIG. 1 will be described in detail in embodiments of the present disclosure with an example of jump of page for live sport event.

In embodiments of the present disclosure, if a user enters a live broadcast page to view live broadcast of a sport event, he/she needs to load the live broadcast page. During the loading of the page, it is needed to obtain the current state information of the live broadcast page from the internal data structure of the live broadcast page, i.e., reading a parameter value of a variable representing the current live broadcast state among various variables of the live broadcast page. The variable representing the current live broadcast state may have any one of parameter values including a parameter value indicating that the live broadcast is not started, a parameter value indicating that the broadcast is in progress, and a parameter value indicating that the live broadcast is finished. For example, if a web page is constructed by js language, the current state of the live broadcast can be output by js variables of the live broadcast page. In embodiments of the present disclosure, when loading the live broadcast page, the parameter value of the variable representing the current live broadcast state can be read from the JS variables of the live broadcast page. The parameter value of the variable representing the current live broadcast state can be indicated by a status field. The status field can have a parameter value of 0, 1 or 2, for example, status=0 means that the live broadcast is not started, status=1 means that the live broadcast is in progress, and status=2 means that the live broadcast is finished.

If the parameter value of the variable representing the current live broadcast state of the live broadcast page when loading the live broadcast page is obtained as status=2, the current live broadcast state of the live broadcast page indicates that the live broadcast is finished. In other words, the user enters the live broadcast page after the end of the live broadcast, and the user cannot view the live broadcast of the sport event at this time; the user can't view the sport event again unless the server and the client end provide on-demand play or replay function; otherwise, the flow for obtaining the current state information of the live broadcast page can be finished.

If the variable representing the current live broadcast state of the live broadcast page when loading the live broadcast page is obtained as status=1 or 0, the current live broadcast state of the live broadcast page indicates that the live broadcast is not finished (in progress or not started). In order to determine whether the current live broadcast state reflects the actual live broadcast state of the live broadcast page, the obtaining request is sent to the server to obtain the actual state information of the live broadcast. When sending the obtaining request to the server, for the purpose of not influencing the current state of the live broadcast page, embodiments of the present disclosure can employ an AJAX technology which is used for creating a quick dynamic web page. That is, an asynchronous request such as an AJAX request is sent to the server, and a small number of data exchange with the server is performed at the background to obtain the actual state information of the live broadcast page. The actual state information includes the parameter value of the variable representing the actual live broadcast state. The parameter value of the variable representing the actual live broadcast state can have any one of parameter values including a parameter value indicating that the live broadcast is not started, a parameter value indicating that the broadcast is in progress, and a parameter value indicating that the live broadcast is finished. In actual situations, the server can return the data of the following format as the actual state information of the live broadcast page:

```
{
    code:200,
    msg:  “OK” ,
    -data:  [
```

| -{ | |
|---|---|
| | id:116079005, |
| | mid:116079003, |
| | matchStatus:1, |
| | competitors: [ ] |
| } | |
| ] , | |
| timestamp: | “20150928152652” |

}

The above data reflects the contents of the actual state information. The contents include the matchstatus field representing the actual live broadcast state and the parameter value thereof. Similarly, the matchstatus field can has a parameter value of 0, 1 or 2, for example, matchstatus=0 means that the live broadcast is not started, matchstatus=1 means that the live broadcast is in progress, and matchstatus=2 means that the live broadcast is finished.

If the parameter value of the variable representing the current live broadcast state of the live broadcast page when loading the live broadcast page is obtained as status=0 and the actual live broadcast state obtained from the server is matchstatus=0, it indicated that the current live broadcast state and the actual live broadcast state of the live broadcast page are the same, i.e., both indicates that the live broadcast is not started. Thus, it is not necessary to refresh the live broadcast page, and later the live broadcast page can be reloaded to obtain the current state information and the actual state information can be obtained from the server for comparison. If the actual live broadcast state obtained from the server is matchstatus=1, the actual live broadcast state of the live broadcast page indicates that the live broadcast is in progress, and thus it is needed to refresh the live broadcast page to enable the live broadcast to jump from the state of not started to in-progress. In this way, page contents matching the actual live broadcast state can be presented for users. Similarly, if the actual live broadcast state obtained from the server is matchstatus=2, the actual live broadcast state of the live broadcast page indicates that the live broadcast is finished. This situation is less likely to occur, because in this situation a user enters the live broadcast page after the live broadcast has been finished. The more common situations are that a user enters the live broadcast page before the live broadcast is started, or after the start of the live broadcast. If the actual live broadcast state obtained from the server is matchstatus=2, which is inconsistent with the parameter value of the variable representing the current live broadcast state status=0, it is needed to refresh the live broadcast page to enable the live broadcast page to jump to the state where the live broadcast has actually been finished.

If the parameter value of the variable representing the current live broadcast state of the live broadcast page when loading the live broadcast page is obtained as status=1 and the actual live broadcast state obtained from the server is matchstatus=1, it indicated that the current live broadcast state and the actual live broadcast state of the live broadcast page are the same, i.e., both indicates that the live broadcast is in progress, which means that the user enters the live broadcast page after the start of the live broadcast. Thus, it is not necessary to refresh the live broadcast page. Further, it is relatively unlikely that the actual live broadcast state obtained from the server is matchstatus=0 or 2. Specifically, the case where the actual live broadcast state obtained from the server is matchstatus=0, which means that the current state of the live broadcast page indicates that the live broadcast is in progress but the actual state at the server indicates that the live broadcast is not started, it barely happens. The only possible explanation for this case is that the actual state information sent from the server is mistaken. Such mistake is caused by the system, and embodiments of the present disclosure can for example specify in advance for such case: when status=1 and matchstatus=0, the live broadcast page is not automatically refreshed. The case where the actual live broadcast state obtained from the server is matchstatus=2, which means that the current state of the live broadcast page indicates that the live broadcast is in progress but the actual state at the server indicates that the live broadcast is finished, it barely happens as well. The only possible explanation for this case is that the live broadcast on the live broadcast page becomes stuck to make the broadcast pause, but the actual broadcast state at the server is that the live broadcast has been finished. However, if the situation where the live broadcast on the live broadcast page becomes stuck and cause a pause of the broadcast, the user may necessarily refresh the page for he/she is viewing the page, and then the above mentioned case will not happen. Then, if status=1 and matchstatus=2 do happens, it is possible that the user is not viewing the live broadcast, and embodiments of the present disclosure may for example refresh the live broadcast page according to the state of matchstatus=2 to enable the page jump to the state where the live broadcast is finished upon determination of inconsistency between status=1 and matchstatus=2.

Among various cases when determining whether the current state information and the actual state information of the live broadcast page are consistent, when the actual state information is consistent with the current state information, polling can be performed for sending the obtaining request to the server according to a preset time interval in embodiments of the present disclosure. By doing this, when it is determined later that the actual state information and the current state information of the live broadcast page are not consistent with each other, the live broadcast page can be refreshed in time to enable the page to jump to a page corresponding to the actual broadcast state. It shall be noted here when the actual state information is consistent with the current state information, polling can be performed for sending the obtaining request to the server according to a preset time interval, and the preset time interval may be set according to users' requirements. Theoretically, if the time interval is set as small enough (which means that the polling is performed in real time to send the obtaining request to the server), it can be guaranteed that when the actual state information of the live broadcast page at the server is not consistent with the current state information of the page at the user side, the state of the page at the user side can be promptly refreshed to a page corresponding to the actual state of the live broadcast page at the server.

Among various cases when determining whether the current state information and the actual state information of the live broadcast page are consistent, when the actual state information is not consistent with the current state information, it is needed to refresh the live broadcast page according to the actual state information, i.e., refreshing the location.href direction of the page (URL address of the current live broadcast page). In embodiments of the present disclosure, when performing the refresh operation, the address of the live broadcast page can be added into the actual state information and then the live broadcast page can be refreshed. Specifically, the new location/URL is transmitted to the matchstatus field to refresh the live broadcast page. For example, if the current URL address of the live broadcast page is http://sports.xxx.com/match/116079003.html?, the current state information is status=0 and the actual state information obtained from the server is matchstatus=1, when refreshing the live broadcast page, matchstatus=1 needs to be added into http://sports.xxx.com/match/116079003.html?, and the live broadcast page is refreshed according to http://sports.xxx.com/match/116079003.html?matchstatus=1 so as to enable live broadcast page to jump from the state where the live broadcast is not started to the state where the live broadcast is in progress. Thus, page contents matching the actual state where the live broadcast is in progress can be automatically presented for users.

Embodiments of the present disclosure provide a device for refreshing a live broadcast page to implement the method as shown in FIG. 1. As shown in FIG. 2, the device can include a determination unit 21, an obtaining unit 22, a consistency determination unit 23 and a refresh unit 24.

The determination unit 22 is configured to obtain current state information of the live broadcast page, and determine whether current live broadcast state of the live broadcast page is finished according to the current state information.

The obtaining unit 22 is configured to, if the determination unit 21 determines that the current live broadcast state of the live broadcast page is not finished, send an obtaining request to a server for obtaining actual state information of the live broadcast page.

The consistency determination unit 23 is configured to determine whether the actual state information is consistent with the current state information.

The refresh unit 24 is configured to, if consistency determination unit 23 determines that the actual state information is not consistent with the current state information, refresh the live broadcast page according to the actual state information.

Further, the determination unit 21 is configured to read a parameter value of a variable representing the current live broadcast state among variables of the live broadcast page, wherein the parameter value of the variable indicates whether the live broadcast is not started, is in progress or is finished. Specifically, when loading the web page constructed by js language, the determination unit 21 obtains the parameter value of the variable representing the current live broadcast state among js variables of the live broadcast page.

Further, the obtaining unit 22 is configured to send an asynchronous request to the server for obtaining the actual state information of the live broadcast page, wherein the actual state information includes a parameter value of a variable representing an actual live broadcast state, and the parameter value of the variable representing the actual live broadcast state indicates whether the live broadcast is not started, is in progress or is finished. Specifically, the obtaining unit 22 sends an AJAX request to the server, and a small number of data exchange with the server is performed at the background to obtain the actual state information of the live broadcast page.

Further, the consistency determination unit 23 is configured to determine whether the parameter value of the variable representing the actual live broadcast state is consistent with the parameter value of the variable representing the current live broadcast state; and the refresh unit 24 is configured to, if the consistency determination unit 23 determines that the parameter value of the variable representing the actual live broadcast state is not consistent with the parameter value of the variable representing the current live broadcast state, refresh the live broadcast page according to the parameter value of the variable representing the actual live broadcast state. In the embodiments of the present disclosure, the refresh unit 24 can refresh the location.href direction of the page (i.e., the URL address of the current live broadcast page).

Further, the refresh unit 24 is configured to add the actual state information into the address of the live broadcast page, and then refreshing the live broadcast page. In embodiments of the present disclosure, when performing refresh, the refresh unit 24 adds the actual state information into the address of the live broadcast page and then refreshes the live broadcast page. For example, the refresh unit 24 can transmit the new location/URL to the matchstatus field to refresh the live broadcast page.

Further, the obtaining unit 22 is configured to, if the consistency determination unit determines that the actual state information is consistent with the current state information, proceed to perform polling for sending the obtaining request to the server according to a preset time interval.

In the device for refreshing a live broadcast page provided by embodiments of the present disclosure, after entry of the live broadcast page, current state information of the live broadcast page is obtained to determine whether a current live broadcast state of the live broadcast page indicates that the live broadcast is finished; if the live broadcast is not finished, an obtaining request is automatically sent to a server to obtain actual state information of the live broadcast page; if it is determined that the actual state information is not consistent with the previously obtained current state information, the live broadcast page is automatically refreshed according to the actual state information to enable the live broadcast page to jump to a page corresponding to the actual broadcast state. The technical solutions in embodiments of the present disclosure realize real-time refresh of the live broadcast page at a client end according to the live broadcast state at the server so as to automatically present page contents matching the actual live broadcast state to users. Thus, the defect in prior arts that users have to manually refresh the pages to enable the state of the live broadcast page to be synchronized with the actual live broadcast state can be overcome.

Further, in the device for refreshing a live broadcast page provided by embodiments of the present disclosure, if the actual state information is consistent with the current state information, the device continues to perform polling for sending the obtaining request to the server according to a preset time interval. Thus, even if the actual state information and the current state information of the live broadcast page are not consistent with each other later, the live broadcast page can be refreshed in time to enable the page to jump to a page corresponding to the actual broadcast state. Further, in the device provided by embodiments of the present disclosure, if there exists an abnormal situation where the current state information of the live broadcast page indicates that the live broadcast is in progress but the actual state information indicates that the live broadcast is not started, the device does not automatically refresh the live broadcast page. Thus, wrong refreshing of the live broadcast page which may result system errors can be avoided.

It shall be noted that the functions of respective units or modules in the above devices for refreshing live broadcast page according to embodiments of the present disclosure can be realized by hardware processors.

Further, an embodiment of the present disclosure further provides a non-transitory computer-readable storage medium storing executable instructions, which can be executed by an electronic device to perform any methods for refreshing a live broadcast page mentioned by embodiments of the present disclosure.

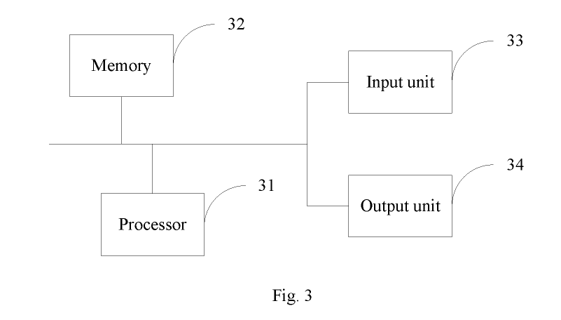

FIG. 3 is a block diagram of an electronic device which is configured to perform the methods for refreshing a live broadcast page according to an embodiment of the present disclosure. As shown in FIG. 3, the device includes: one or more processors 31 and memory 32. A processor 31 is showed in FIG. 3 for an example.

Device which is configured to perform the methods for refreshing a live broadcast page can also include: input unit 33 and output unit 34.

Processor 31, memory 32 input unit 33 and output unit 34 can be connected by BUS or other methods, and BUS connecting is showed in FIG. 3 for an example.

Memory 32 can be used for storing non-transitory software program, non-transitory computer executable program and modules as a non-transitory computer-readable storage medium, such as corresponding program instructions/modules for the methods for refreshing a live broadcast page mentioned by embodiments of the present disclosure (such as shown in FIG. 2, determination unit 21, obtaining unit 22, consistency determination unit 23 and refresh unit 24). Processor 31 performs kinds of functions and refreshing a live broadcast page of the electronic device by executing non-transitory software program, instructions and modules which are stored in memory 32 thereby realizes the methods for refreshing a live broadcast page mentioned by embodiments of the present disclosure.

Memory 32 can include program storage area and data storage area, thereby the operating system and applications required by at least one function can be stored in program storage area and data created by using the device for refreshing a live broadcast page can be stored in data storage area. Furthermore, memory 32 can include high speed Random-access memory (RAM) or non-volatile memory such as magnetic disk storage device, flash memory device or other non-volatile solid state storage devices. In some embodiments, memory 32 can include long-distance setup memories relative to processor 31, which can communicate with the device for refreshing a live broadcast page by networks. The examples of said networks are including but not limited to Internet, Intranet, LAN, mobile Internet and their combinations.

Input unit 33 can be used to receive inputted number, character information and key signals causing user configures and function controls of the device for refreshing a live broadcast page. Output unit 34 can include a display screen or a display device.

The said module or modules are stored in memory 32 and perform the methods for refreshing a live broadcast page when executed by one or more processors 31.

The said device can reach the corresponding advantages by including the function modules or performing the methods provided by embodiments of the present disclosure. Those methods can be referenced for technical details which may not be completely described in this embodiment.

Electronic devices in embodiments of the present disclosure can be existences with different types, which are including but not limited to:

(1) Mobile Internet devices: devices with mobile communication functions and providing voice or data communication services, which include smartphones (e.g. iPhone), multimedia phones, feature phones and low-cost phones.

(2) Super mobile personal computing devices: devices belong to category of personal computers but mobile internet function is provided, which include PAD, MID and UMPC devices, e.g. iPad.

(3) Portable recreational devices: devices with multimedia displaying or playing functions, which include audio or video players, handheld game players, e-book readers, intelligent toys and vehicle navigation devices.

(4) Servers: devices with computing functions, which are constructed by processors, hard disks, memories, system BUS, etc. For providing services with high reliabilities, servers always have higher requirements in processing ability, stability, reliability, security, expandability, manageability, etc., although they have a similar architecture with common computers.

(5) Other electronic devices with data interacting functions.

The embodiments of devices are described above only for illustrative purposes. Units described as separated portions may be or may not be physically separated, and the portions shown as respective units may be or may not be physical units, i.e., the portions may be located at one place, or may be distributed over a plurality of network units. A part or whole of the modules may be selected to realize the objectives of the embodiments of the present disclosure according to actual requirements.

In view of the above descriptions of embodiments, those skilled in this art can well understand that the embodiments can be realized by software plus necessary hardware platform, or may be realized by hardware. Based on such understanding, it can be seen that the essence of the technical solutions in the present disclosure (that is, the part making contributions over prior arts) may be embodied as software products. The computer software products may be stored in a computer readable storage medium including instructions, such as ROM/RAM, a magnetic disk, an optical disk, to enable a computer device (for example, a personal computer, a server or a network device, and so on) to perform the methods of all or a part of the embodiments.

It shall be noted that the above embodiments are disclosed to explain technical solutions of the present disclosure, but not for limiting purposes. While the present disclosure has been described in detail with reference to the above embodiments, those skilled in this art shall understand that the technical solutions in the above embodiments can be modified, or a part of technical features can be equivalently substituted, and such modifications or substitutions will not make the essence of the technical solutions depart from the spirit or scope of the technical solutions of various embodiments in the present disclosure.

What is claimed is:

1. A method for refreshing a live broadcast page for a live broadcast, implemented by a client, comprising:
obtaining current state information of the live broadcast page, and determining whether current live broadcast state of the live broadcast page is finished according to the current state information;
if determining that the current live broadcast state of the live broadcast page is not finished, sending an obtaining request to a server for obtaining actual state information of the live broadcast page;
determining whether the actual state information is consistent with the current state information; and
if the actual state information is not consistent with the current state information, refreshing the live broadcast page according to the actual state information.

2. The method according to claim 1, wherein obtaining current state information of the live broadcast page, comprises:
reading a parameter value of a variable representing the current live broadcast state among variables of the live broadcast page, wherein the parameter value of the variable representing the current live broadcast state indicates whether the live broadcast is not started, is in progress or is finished.

3. The method according to claim 2, wherein sending the obtaining request to the server for obtaining the actual state information of the live broadcast page, comprises:
sending an asynchronous request to the server for obtaining the actual state information of the live broadcast page, wherein the actual state information comprises a parameter value of a variable representing an actual live broadcast state, and the parameter value of the variable representing the actual live broadcast state indicates whether the live broadcast is not started, is in progress or is finished.

4. The method according to claim 3, wherein determining whether the actual state information is consistent with the current state information, comprises:
determining whether the parameter value of the variable representing the actual live broadcast state is consistent with the parameter value of the variable representing the current live broadcast state;
wherein refreshing the live broadcast page according to the actual state information, comprises:
if the parameter value of the variable representing the actual live broadcast state is not consistent with the parameter value of the variable representing the current live broadcast state, refreshing the live broadcast page according to the parameter value of the variable representing the actual live broadcast state.

5. The method according to claim 1, wherein refreshing the live broadcast page according to the actual state information, comprises:
adding the actual state information into the address of the live broadcast page, and then refreshing the live broadcast page.

6. The method according to claim 1, wherein after determining whether the actual state information is consistent with the current state information, the method further comprises:
if determining that the actual state information is consistent with the current state information, proceeding to perform polling for sending the obtaining request to the server according to a preset time interval.

7. An electronic device, comprising:
at least one processor; and
a memory communicably connected with the at least one processor for storing instructions executable by the at least one processor, wherein execution of the instructions by the at least one processor causes the at least one processor to:
obtain current state information of a live broadcast page, and determine whether current live broadcast state of the live broadcast page is finished according to the current state information;
if determining that the current live broadcast state of the live broadcast page is not finished, send an obtaining request to a server for obtaining actual state information of the live broadcast page;
determine whether the actual state information is consistent with the current state information; and
if the actual state information is not consistent with the current state information, refresh the live broadcast page according to the actual state information.

8. The electronic device according to claim 7, wherein obtaining current state information of the live broadcast page comprises:
reading a parameter value of a variable representing the current live broadcast state among variables of the live broadcast page, wherein the parameter value of the variable representing the current live broadcast state indicates whether the live broadcast is not started, is in progress or is finished.

9. The electronic device according to claim 8, wherein sending the obtaining request to the server for obtaining the actual state information of the live broadcast page comprises:
sending an asynchronous request to the server for obtaining the actual state information of the live broadcast page;
wherein the actual state information comprises a parameter value of a variable representing an actual live broadcast state, and the parameter value of the variable representing the actual live broadcast state indicates whether the live broadcast is not started, is in progress or is finished.

10. The electronic device according to claim 9, wherein determining whether the actual state information is consistent with the current state information comprises:
determining whether the parameter value of the variable representing the actual live broadcast state is consistent with the parameter value of the variable representing the current live broadcast state;
wherein refreshing the live broadcast page according to the actual state information comprises:
if the parameter value of the variable representing the actual live broadcast state is not consistent with the parameter value of the variable representing the current live broadcast state, refreshing the live broadcast page according to the parameter value of the variable representing the actual live broadcast state.

11. The electronic device according to claim 7, wherein refreshing the live broadcast page according to the actual state information comprises:
adding the actual state information into the address of the live broadcast page, and then refreshing the live broadcast page.

12. The electronic device according to claim 7, wherein after determining whether the actual state information is consistent with the current state information, wherein the instructions are executed to cause the at least one processor to:
if determining that the actual state information is consistent with the current state information, proceed to perform polling for sending the obtaining request to the server according to a preset time interval.

13. A non-transitory computer-readable storage medium storing executable instructions that, when executed by an electronic device with a touch-sensitive display, cause the electronic device to:
obtain current state information of a live broadcast page, and determine whether current live broadcast state of the live broadcast page is finished according to the current state information;
if determining that the current live broadcast state of the live broadcast page is not finished, send an obtaining request to a server for obtaining actual state information of the live broadcast page;
determine whether the actual state information is consistent with the current state information; and
if the actual state information is not consistent with the current state information, refresh the live broadcast page according to the actual state information.

14. The non-transitory computer-readable storage medium according to claim 13, wherein obtaining current state information of the live broadcast page comprises:
reading a parameter value of a variable representing the current live broadcast state among variables of the live broadcast page, wherein the parameter value of the variable representing the current live broadcast state indicates whether the live broadcast is not started, is in progress or is finished.

15. The non-transitory computer-readable storage medium according to claim 14, wherein sending the obtaining request to the server for obtaining the actual state information of the live broadcast page comprises:
sending an asynchronous request to the server for obtaining the actual state information of the live broadcast page;
wherein the actual state information comprises a parameter value of a variable representing an actual live broadcast state, and the parameter value of the variable representing the actual live broadcast state indicates whether the live broadcast is not started, is in progress or is finished.

16. The non-transitory computer-readable storage medium according to claim 15, wherein determining whether the actual state information is consistent with the current state information comprises:
determining whether the parameter value of the variable representing the actual live broadcast state is consistent with the parameter value of the variable representing the current live broadcast state;
wherein refreshing the live broadcast page according to the actual state information, comprises:
if the parameter value of the variable representing the actual live broadcast state is not consistent with the parameter value of the variable representing the current live broadcast state, refreshing the live broadcast page according to the parameter value of the variable representing the actual live broadcast state.

17. The non-transitory computer-readable storage medium according to claim 13, wherein refreshing the live broadcast page according to the actual state information comprises:
adding the actual state information into the address of the live broadcast page, and then refreshing the live broadcast page.

18. The non-transitory computer-readable storage medium according to claim 13, wherein after determining whether the actual state information is consistent with the current state information, wherein the executable instructions are executed to cause the electronic device to:
if determining that the actual state information is consistent with the current state information, proceed to perform polling for sending the obtaining request to the server according to a preset time interval.
